(19) United States
(12) Patent Application Publication
(10) Pub. No.: US 2025/0308264 A1
(43) Pub. Date: Oct. 2, 2025

(54) IMAGE ACQUISITION SYSTEM AND IMAGE ACQUISITION METHOD

(71) Applicant: CANON KABUSHIKI KAISHA, Tokyo (JP)

(72) Inventors: ICHIRO HARADA, Kanagawa (JP); SHUHEI TOBA, Kanagawa (JP)

(21) Appl. No.: 19/089,556

(22) Filed: Mar. 25, 2025

(30) Foreign Application Priority Data
Mar. 26, 2024 (JP) 2024-050582

(51) Int. Cl. G06V 20/69; G01N 15/10; G01N 15/14; G06V 10/25; G06V 10/60; G06V 10/75

(52) U.S. Cl. CPC G06V 20/695; G01N 15/1456; G06V 10/25; G06V 10/60; G06V 10/759; G06V 20/693; G06V 20/698; G01N 2015/1006

(57) ABSTRACT

An image acquisition system is configured to acquire an image of a floating cell included in a cell suspension within a vessel, and includes a transmitted light image capturing unit configured to acquire a transmitted light image of the floating cell, a fluorescence image capturing unit configured to acquire a fluorescence image of the floating cell, and an information acquisition unit configured to acquire information about an image capturing condition for the fluorescence image using a first transmitted light image captured at a first time and a second transmitted light image captured at a second time different from the first time.

### BACKGROUND OF THE DISCLOSURE

### Field of the Disclosure

The present disclosure relates to a cell image acquisition system and a cell image acquisition method.

### Description of the Related Art

To analyze a suspension of cells, cells are subjected to staining or the like for use in fluorescence measurement and the suspension of cells thus prepared is analyzed by flow cytometry in many cases. A typical flow cytometry analysis requires a relatively large number of cells to be analyzed. Accordingly, if a required number of cells cannot be obtained, it is difficult to perform the analysis. As an alternative means for such a case, it is possible to make a preparation such as a counting chamber and observe or re-examine the cells with a microscope. However, this alternative means has such an issue that reconcentration of the suspension of cells by centrifugal separation is required to analyze the entirety of a small number of cells and it is difficult to reconcentrate the suspension of cells because the suspension includes only a small number of cells. For this reason, a process in which the entirety of the cell suspension is transferred into a petri dish, a multiwell plate, or the like to observe and measure the cell suspension with a microscope is often carried out.

Japanese Patent Application Laid-Open No. 2007-178193 discusses a method for capturing an image of a target cell in a state where a suspension including floating cells is allowed to stand in a culture vessel and the cells are observed by focusing on the nuclei of the cells. In the related art, however, there is still room for improvement in the method of capturing an image of a target cell.

The method discussed in Japanese Patent Application Laid-Open No. 2007-178193 has such an issue that there is a need to observe a target cell by focusing on the target cell and it is difficult to focus on a plurality of cells.

### SUMMARY OF THE DISCLOSURE

The present disclosure is directed to providing an image acquisition system and an image acquisition method for acquiring a fluorescence image of a floating cell included in a cell suspension within a vessel at an appropriate timing.

According to an aspect of the present disclosure, an image acquisition system is configured to acquire an image of a floating cell included in a cell suspension within a vessel, and includes a transmitted light image capturing unit configured to acquire a transmitted light image of the floating cell, a fluorescence image capturing unit configured to acquire a fluorescence image of the floating cell, and an information acquisition unit configured to acquire information about an image capturing condition for the fluorescence image using a first transmitted light image captured at a first time and a second transmitted light image captured at a second time different from the first time.

Further features of the present disclosure will become apparent from the following description of exemplary embodiments with reference to the attached drawings.

### BRIEF DESCRIPTION OF THE DRAWINGS

FIG. 1 is a functional block diagram illustrating an image acquisition system according to an exemplary embodiment of the present disclosure.

FIG. 2 is a conceptual diagram illustrating a measurement of a change in the position of each cell in a solution based on a difference between two transmitted light images according to the exemplary embodiment.

FIG. 3 illustrates a specific example of a transmitted light image captured at a defocus position according to the exemplary embodiment.

FIG. 4 illustrates a specific example of cell regions extracted from the transmitted light image captured at the defocus position according to the exemplary embodiment.

FIG. 5 illustrates a specific example of a measurement of a cell that is moving in parallel instead of resting within a vessel according to the exemplary embodiment.

FIG. 6 illustrates a specific example of a measurement of a cell that is moving in a height direction instead of resting within the vessel according to the exemplary embodiment.

FIG. 7 illustrates a specific example of a measurement of a fluorescence luminance by measuring cells resting within the vessel according to the exemplary embodiment.

FIG. 8 is a flowchart illustrating processing (image acquisition method) to be performed by an image capturing system to measure the number of cells resting in a cell suspension according to the exemplary embodiment.

FIG. 9 is a conceptual diagram illustrating an input condition according to the exemplary embodiment.

FIG. 10 is a block diagram illustrating a hardware configuration example of the image acquisition system according to the exemplary embodiment.

### DESCRIPTION OF THE EMBODIMENTS

Exemplary embodiments will be described in detail with reference to the attached drawings. The exemplary embodiments are not intended to limit the configurations described in the exemplary embodiments unless the characteristic functions of the claimed disclosure are impaired. In the attached drawings, the same reference numeral is given to the same or similar components, and repeated descriptions are omitted.

To analyze a suspension of floating cells with a microscope, it may be desirable to perform image capturing in a state where a desired number of cells are present on a predetermined focus plane. Accordingly, it is necessary to wait for the cells to settle to the bottom of a vessel. However, because the rate at which a cell settles varies depending on a solution or cell species, the times required for cells to settle to the bottom of a culture vessel are different, which makes it difficult to wait for an appropriate timing for measurement. Although it may be possible to wait for a desired number of cells to settle to the bottom of a petri dish, there is an issue that it is desirable to determine an appropriate image capturing timing immediately so as to prevent bleaching of fluorescence or prevent the state of each living cell from being changed in a living cell analysis.

An image acquisition system according to an exemplary embodiment of the present disclosure can resolve the above-described issues. In other words, it is possible to provide an image acquisition system and an image acquisition method for acquiring a fluorescence image of a floating cell included in a cell suspension within a vessel at an appropriate timing.

### Image Acquisition System

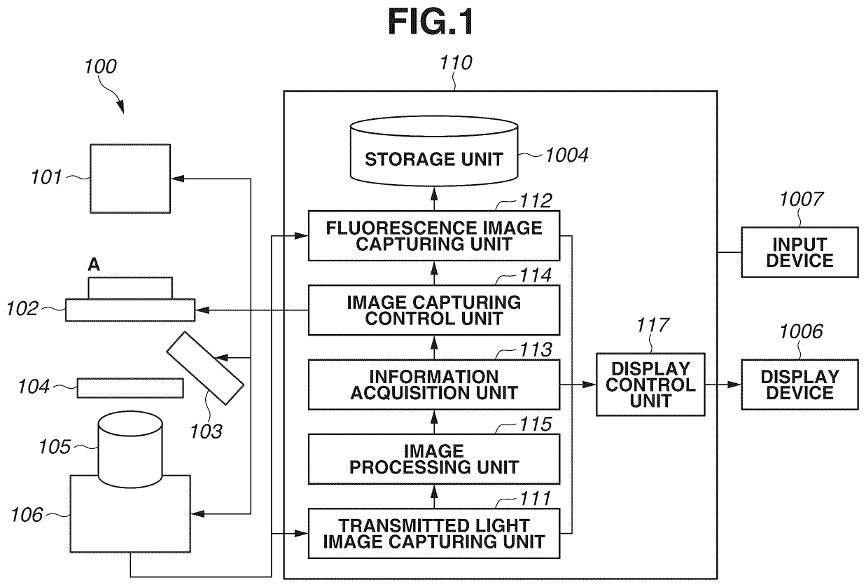

An image acquisition system for acquiring an image of a floating cell included in a cell suspension within a vessel according to an exemplary embodiment of the present disclosure will be described with reference to FIG. 1. An image acquisition system 100 according to the present exemplary embodiment includes a transmitted light image capturing unit 111 that acquires a transmitted light image of a floating cell, a fluorescence image capturing unit 112 that acquires a fluorescence image of the floating cell, and an information acquisition unit 113 that acquires information about an image capturing condition for the fluorescence image using a first transmitted light image captured at a first time and a second transmitted light image captured at a second time different from the first time. In the image acquisition system 100 according to the present exemplary embodiment, for example, the information acquisition unit 113 is configured to acquire information about an appropriate timing for capturing the fluorescence image based on a plurality of transmitted light images captured at different times, respectively. Consequently, the fluorescence image in which a required number of cells to be used for analyzing the cells are captured can be acquired.

The image acquisition system 100 according to the present exemplary embodiment transmits a notification about a timing when a required number of floating cells in the cell suspension reach a focus plane and an image of each cell can be captured using an imager such as a microscope, and captures a fluorescence image of each cell, or performs image capturing upon transmission of the notification. Accordingly, the fluorescence image can be acquired at an appropriate timing when the image capturing operation and the analysis can be rapidly performed during a cell analysis using a cell observation apparatus such as a microscope.

Information about an image capturing condition for the fluorescence image may be acquired using three or more transmitted light images captured at three or more different times, respectively.

The image acquisition system 100 according to the present exemplary embodiment may include an image capturing control unit 114 that controls acquisition of a fluorescence image by capturing an image of a floating cell based on the information about the image capturing condition acquired by the information acquisition unit 113.

The image acquisition system 100 according to the present exemplary embodiment may include an image processing unit 115 that performs processing of extracting a cell region in which the floating cell is present in the transmitted light image. The image processing unit 115 may acquire image information about at least one of the cell region and a region outside of the cell region. The information acquisition unit 113 may acquire the information about the image capturing condition for the fluorescence image based on the image information acquired by the image processing unit 115.

The image acquisition system 100 according to the present exemplary embodiment may include an image capturing unit 106 that acquires the transmitted light image and the fluorescence image by capturing an image of the floating cell.

The image acquisition system 100 according to the present exemplary embodiment may include a display control unit 117 that controls display of information about a timing for acquiring the fluorescence image on a display device 1006 based on the information about the image capturing condition.

The image acquisition system 100 according to the present exemplary embodiment may include a storage unit 1004 that stores the fluorescence image of the floating cell acquired by the fluorescence image capturing unit 112.

A configuration including the transmitted light image capturing unit 111, the fluorescence image capturing unit 112, the information acquisition unit 113, the image capturing control unit 114, the image processing unit 115, and the display control unit 117 can also be referred to as an information processing unit 110. An input device 1007 that is used to operate the information processing unit 110 may also be included.

An example of the image acquisition system 100 according to the present exemplary embodiment will be described in detail with reference to FIG. 1.

A cell suspension within a vessel A that is placed on a mount portion (stage) 102 is irradiated with light from an illumination portion 101, and the image capturing unit 106 captures an image of each floating cell in the cell suspension to acquire a transmitted light image (brightfield image). In the case of focusing on the cells to be captured by the image capturing unit 106, or in the case of changing the focus plane in the cell suspension, a lens 105 is used. In the case of acquiring a transmitted light image to determine whether each cell is resting, the illumination portion 101 may be controlled to be turned on only for a required period of time for image capturing so as to prevent bleaching of fluorescence subjected to dyeing or the like.

When the cell suspension within the vessel A placed on the mount portion (stage) 102 is irradiated with light from a light source portion 103, each floating cell in the cell suspension emits fluorescence. The image capturing unit 106 performs image capturing based on the emitted fluorescence, thereby acquiring the fluorescence image. A filter 104 for cutting a wavelength other than a fluorescence wavelength with which image capturing is to be performed may be provided between the image capturing unit 106 and the vessel A.

A configuration including the illumination portion 101, the light source portion 103, the filter 104, and the lens 105 can also be referred to as an optical system. Specifically, the optical system is configured to allow a user to observe the cell suspension within the vessel A set on the stage 102 by transmitted light that has been emitted from the illumination portion 101 via the lens 105 and has been transmitted through the culture vessel A, and to capture an image of each floating cell in the cell suspension.

### Information Processing Unit

To implement functions as a computer to perform calculations and storage, the information processing unit 110 according to the present exemplary embodiment includes a central processing unit (CPU) 1001, a random access memory (RAM) 1002, a read-only memory (ROM) 1003, and a hard disk drive (HDD) 1004. These components implement the functions of the transmitted light image capturing unit 111, the fluorescence image capturing unit 112, the information acquisition unit 113, the image capturing control unit 114, the image processing unit 115, and the display control unit 117.

An information processing system 1000 includes a communication interface (I/F) 1005, the display device 1006, and the input device 1007. The CPU 1001, the RAM 1002, the ROM 1003, the HDD 1004, the communication I/F 1005, the display device 1006, and the input device 1007 are interconnected via a bus 1010. The display device 1006 and the input device 1007 may be connected to the bus 1010 via a drive apparatus (not illustrated) for driving these devices.

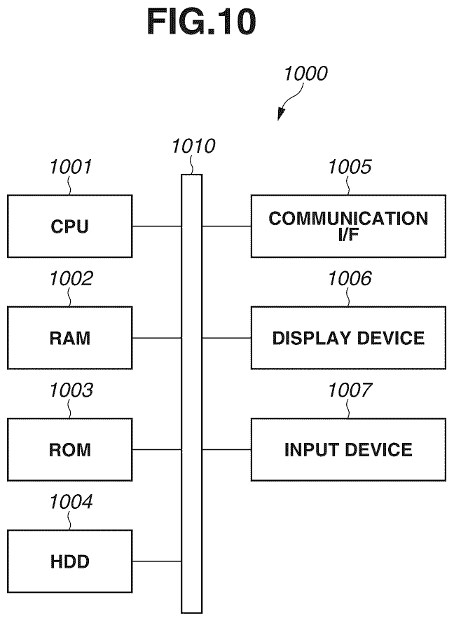

While FIG. 10 illustrates an example where the units included in the information processing system 1000 are illustrated as integrated devices, some of these functions may be configured as external devices. For example, the display device 1006 and the input device 1007 may be external devices that are separate from the portion included in the functions of the computer, including the CPU 1001.

The CPU 1001 also includes a function for performing a predetermined operation based on a program stored in the RAM 1002, the HDD 1004, or the like, and controlling each unit of the information processing system 1000. The RAM 1002 is composed of a volatile storage medium and provides a temporary memory area to be used for the operation of the CPU 1001. The ROM 1003 is composed of a non-volatile storage medium and stores required information such as programs to be used for the operation of the information processing system 1000. The HDD 1004 is a storage device composed of a non-volatile storage medium.

The communication I/F 1005 is a communication interface based on standards such as wireless fidelity (Wi-Fi®), 4G, or the like, and is a module for establishing communication with another device. The display device 1006 is a liquid crystal display, an organic light emitting diode (OLED) display, or the like, and is used to display moving images, still images, characters, and the like. The input device 1007 includes buttons, a touch panel, a keyboard, and a pointing device, and is used for the user to operate the information processing system 1000. The display device 1006 and the input device 1007 may be integrally formed as a touch panel. The user can operate the input device 1007 to output various instructions to the image capturing control unit 114, and the image capturing control unit 114 and the image processing unit 115 are also configured to execute various processes in response to instructions from the user. The display control unit 117 that controls display on the display device 1006 may also be included.

The hardware configuration illustrated in FIG. 10 is merely an example, and devices other than the above-described devices may be added. Some of the devices may be omitted, or some of the devices may be replaced with another device including similar functions. Some of the functions may be provided by another device via a network, or the functions included in the present exemplary embodiment may be implemented by being distributed to a plurality of devices. For example, the HDD 1004 may be replaced with a solid-state drive (SSD) using a semiconductor element such as a flash memory, or may be replaced with a cloud storage.

### Image Processing Unit

The image processing unit 115 extracts cell regions from a cell morphology image acquired by the image data acquisition unit 113. The phrase “extracting cell regions” indicates extracting the morphology of cells that are placed within an observation field of view and are present discretely to acquire information about cell regions, or indicates extracting the morphology of each group of cells, which are in close contact with each other and are present in a mass state, and the entire mass to acquire information about the region of each cell group.

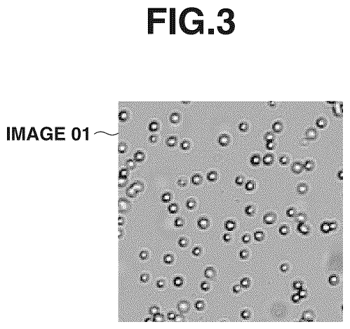

In the present exemplary embodiment, the cell region extraction process may be performed by a known image analysis method. For example, in the case of using a defocused image acquired as an image 01 illustrated in FIG. 3, threshold processing can be performed to extract cell contour information indicating a boundary between cell regions. A mask image in which the region on the inside of the extracted cell contour is painted with black pixels and the region on the outside of the extracted cell contour is painted with white pixels is created. Then, labeling processing is performed on isolated black pixel regions to assign an identifier to each region, thereby making it possible to identify each cell region in the cell image.

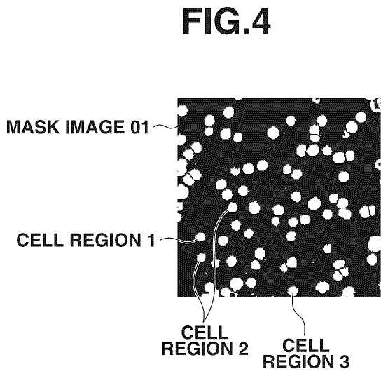

FIG. 4 illustrates an example of a mask image 01 that is created for the defocused image 01. The mask image 01 is an enlarged image of some of small regions. Cell regions 1 to 3 illustrate some of cell regions labelled based on the mask image 01. It can be assumed that the number of regions extracted as described above is equal to the number of cells. In the present exemplary embodiment, it is assumed that the number of cells is equal to the number of extracted regions.

While the present exemplary embodiment illustrates an example where a defocused image captured by a red, green, and blue (RGB)-color camera is used, this cell region extraction process can also be applied to an image in which the contrast of the contour portion of each cell is more enhanced than non-cell regions. For example, an image observed with a phase contrast microscope, or an image subjected to image processing so as to enhance the contour portion of each cell may also be used.

### Information Acquisition Unit

The information acquisition unit 113 according to the present exemplary embodiment may acquire an image capturing condition based on a difference between luminance of a cell region in a first transmitted light image and luminance of a cell region in a second transmitted light image.

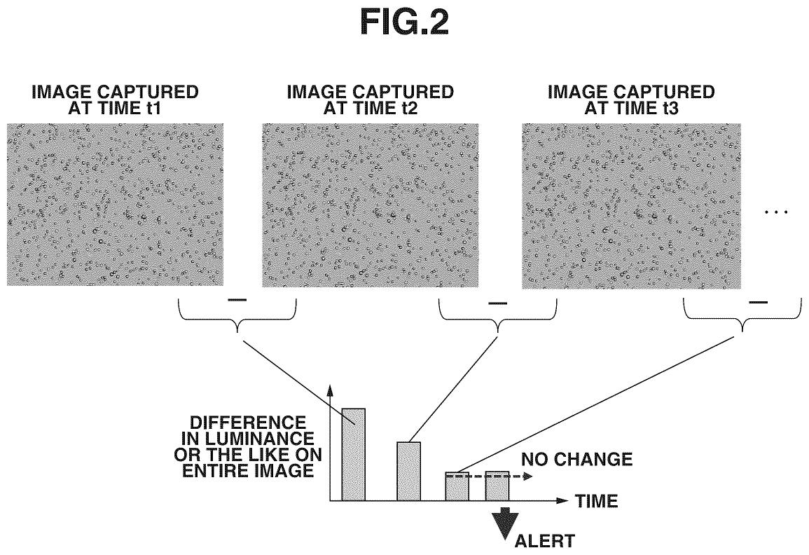

A determination of a state where cells within a vessel are almost resting may be made based on a change between two or more images. For example, if the absolute value of the total amount of the difference between two or more transmitted light images captured as illustrated in FIG. 2 is large, for example, it can be determined that the position of each cell in the solution has changed greatly. Not all cells contained in the cell suspension completely settle to the bottom of the vessel and rest on the bottom. The difference may include a difference in change of the image contrast due to vibrations of the cell suspended solution or the like. In such a case, the difference between two or more images does not become “0”. In the determination as to whether cells are resting, a determination threshold may be set in advance depending on the resolution of the optical system or the resolution of the camera. At a time when the difference between the images is less than or equal to the threshold, an alert may be output, or the processing may proceed to the subsequent process. This determination method may be used, for example, when there is a possibility that the cell suspension within the vessel has changed greatly. This determination method need not necessarily be performed. If the number of suspended cells cannot be estimated or is unknown, the user cannot set a desired number of cells to be analyzed. Accordingly, the processing may proceed to the cell region extraction process at a timing when it is determined that a change in the difference between two or more images is small according to the determination method.

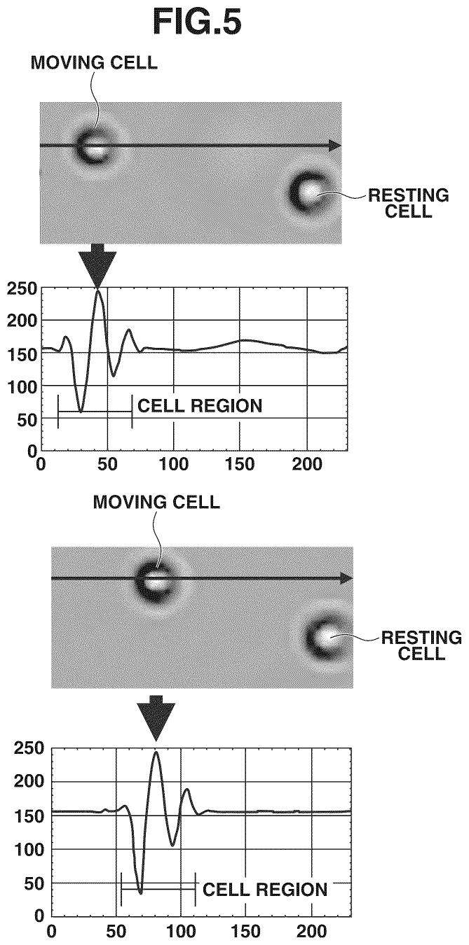

If cells are moving in a plane direction perpendicular to an optical path, the image determination method may be performed by a known image analysis method. However, this determination process can be performed based on a difference in the coordinates of the centroid of each region determined to be a cell region by a comparison between two or more images, for example, as illustrated in FIG. 5. While FIG. 5 illustrates an example where a one-dimensional centroid is calculated, a two-dimensional centroid may be calculated. The corresponding pixels of the images may not exactly match each other due to effects of image noise, a change in the contrast of the solution, or the like. Accordingly, it may be desirable to preliminarily set the determination threshold depending on the resolution of the optical system or the resolution of the camera so that it can be determined that cells are resting. For example, if the number of pixels corresponding to the radius of a target cell may be set as a threshold, and if a distance by which the centroid position of a cell has moved is smaller than the threshold, it may be determined that the cell has not moved in parallel.

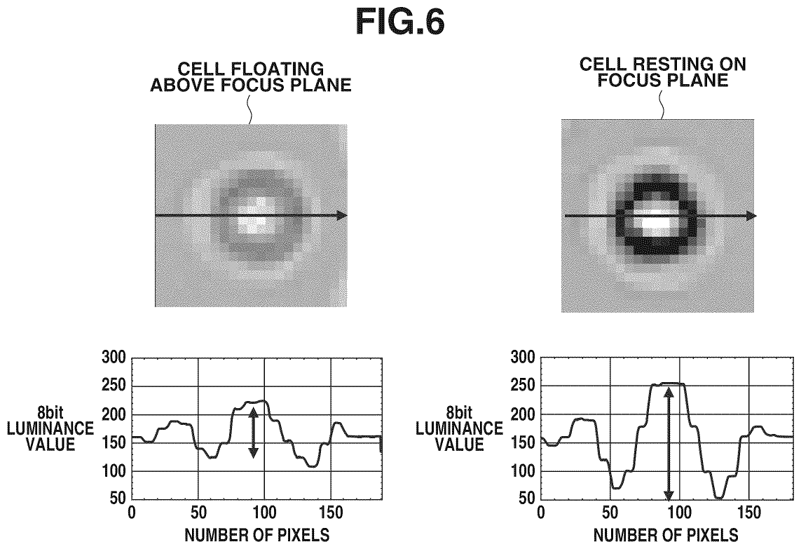

A known image analysis method may be used to determine whether only positional information about the height parallel to the optical path has changed, the determination may also be performed based on a change in information about an average value or variation of luminance in a cell region, or a change in the contrast of the contour of each cell region as illustrated in FIG. 6. FIG. 6 illustrates a difference between a maximum value and a minimum value of luminance in a cell region as an example. In the example illustrated in FIG. 6, the difference between the minimum value and the maximum value among the luminance values in a cell floating above the focus plane is “100”, and the difference between the minimum value and the maximum value among the luminance values in a cell resting on the focus plane is “200”.

For example, a determination as to whether a cell is moving vertically can be made based on these differences. The corresponding pixels of the images may not exactly match each other and the difference between the images may not become “0” due to effects of image noise, a change in the contrast of the solution, or the like. For this reason, it may be desirable to preliminarily set the determination threshold depending on the resolution of the optical system or the resolution of the camera so that it can be determined that cells are resting. For example, in the example as illustrated in FIG. 6, if a change in the difference between the minimum value and the maximum value is less than or equal to “25”, it may be determined that the cell has not moved vertically. While the present exemplary embodiment illustrates an example where the determination is made based on a change in the difference between the minimum value and the maximum value, the present exemplary embodiment is not limited to this example. Alternatively, a difference in the height direction may be determined based on a parameter such as an average value, a variation, or a median within a region as information about the luminance in a cell region. Such a parameter is calculated based on luminance information within each region.

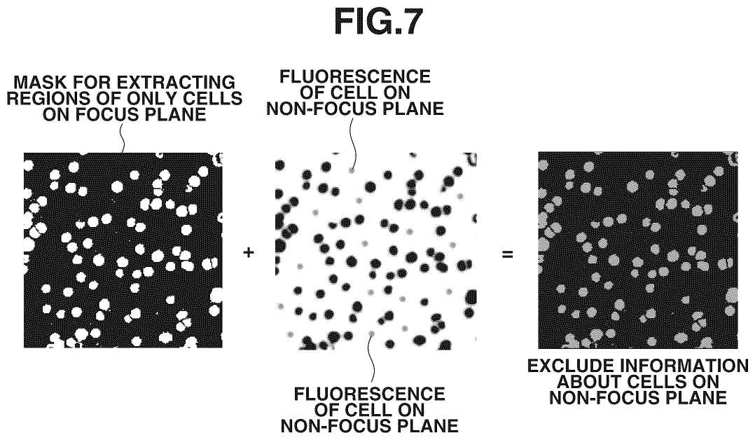

A mask image generated based on a brightfield image used to determine that a desired number of cells have finally reached an appropriate focus plane may be used to extract the luminance of a fluorescence image captured in the subsequent step. Specifically, the mask image generated based on the brightfield image acquired immediately after it is determined that the desired number of cells are resting or there is no change in the image as illustrated in FIG. 7 may be superimposed on a fluorescence image or the like captured immediately after the determination, thereby making it possible to set only cells resting on a predetermined focus plane as cells to be analyzed.

### Image Capturing Control Unit

The image capturing control unit 114 according to the present exemplary embodiment determines the state of resting floating cells included in an image and a change in the plane and height position in such a manner that the information acquisition unit 113 acquires information about an image capturing condition using transmitted light images captured by the image capturing unit 106.

### Image Capturing Unit, Lens

The image capturing unit 106 according to the present exemplary embodiment may be configured to capture both the transmitted light image and the fluorescence image described above. The image capturing unit 106 used to capture the transmitted light image and the image capturing unit 106 used to capture the fluorescence image may be separate from each other. The image capturing unit (camera) 106 includes an image sensor such as a complementary metal-oxide semiconductor (CMOS) sensor, and acquires an image input through the lens 105. The image captured through the lens 105 may be a phase difference image. The above-described optical system may be configured to detect a change in the phase of transmitted light that has transmitted through a cell by defocusing and to identify cells present on the same focus plane based on a change generated in an image to be formed depending on the distance between the cell and the lens 105. The lens 105 according to the present exemplary embodiment may be configured to, for example, focus light that has transmitted through a cell having a diameter in a range from 1 μm to 100 μm.

In a case where the image capturing unit 106 captures an image to acquire a fluorescence image, for example, the light source portion 103 emits light of a specific wavelength to obtain fluorescence of a fluorescence-labeled cell or a fluorescence image by autofluorescence of the cell itself.

### Filter

A filter for cutting excitation light or an unwanted fluorescence wavelength can be used as the filter 104 according to the present exemplary embodiment. The fluorescence that has transmitted through the filter 104 passes through the lens 103 and reaches the image capturing unit 106 to perform image capturing. An incident-light coaxial lighting fluorescence device that is located on the same side of excitation light with respect to the bottom surface of a vessel can be used to acquire the fluorescence. The optical axis of the excitation light need not necessarily be coaxial with the optical axis of the fluorescence as long as a fluorescence image can be acquired. Two or more fluorescence images with different combinations of conditions for an excitation light wavelength and cut filter characteristics of an image capturing unit may be acquired.

### Mount Portion

The mount portion (stage) 102 according to the present exemplary embodiment may be electrically controlled to continuously capture images of a vessel such as a multiwell plate. The mount portion (stage) 102 or the lens 105 may be an electric autofocus so as to continuously capture images of a multiwell plate or the like.

### Information about Image Capturing Condition

Information about an image capturing condition according to the present exemplary embodiment may be at least one selected from the group consisting of information indicating that a fluorescence image can be captured, information indicating a time when a fluorescence image can be captured, information indicating that the number of floating cells present at a predetermined height within a vessel is more than or equal to a threshold, and information indicating that a floating cell is resting on the bottom surface of the vessel.

### Vessel

Examples of a vessel according to the present exemplary embodiment include a culture vessel for culturing floating cells, such as a flask or a well plate.

The image acquisition system 100 according to the present exemplary embodiment is suitably used when a multiwell plate including a plurality of wells each containing a cell suspension is used as the vessel. Specifically, in a case where each well of the multiwell plate used as the vessel is filled with a cell suspension and each well is continuously measured while the stage 102 is moved, the resting cells are shaken and moved every time the stage 102 is moved. In such a case, a fluorescence image is acquired under appropriate conditions for each well. This configuration makes it possible to continuously perform image capturing and measurement of the multiwell plate, so that images of floating cells can be captured at high throughput. Cells whose images can be captured at a timing when the cells are resting on an appropriate focus plane can be detected during image capturing, which reduces the necessity for the user to concern that the cells to be analyzed may include inappropriate cells that are not present on the focus plane.

### Floating Cells

Floating cells according to the present exemplary embodiment are not particularly limited as long as the cells are floating in a culture medium within a vessel and are cultured.

### Image Acquisition Method

An image acquisition method according to the present exemplary embodiment is an image acquisition method for acquiring an image of a floating cell included in a cell suspension within a vessel, and the image acquisition method includes a transmitted light image acquisition step of acquiring a transmitted light image of the floating cell, a fluorescence image acquisition step of acquiring a fluorescence image of the floating cell, and an information acquisition step of acquiring information about an image capturing condition for the fluorescence image using a first transmitted light image captured at a first time and a second transmitted light image captured at a second time different from the first time. The image acquisition method will be described in detail.

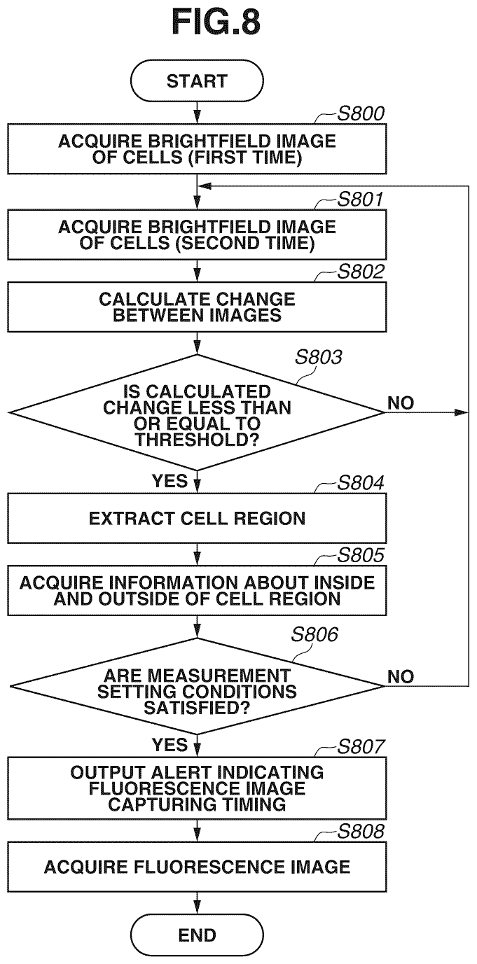

FIG. 8 is a flowchart illustrating processing (image acquisition method) to be performed by the image acquisition system 100 for acquiring an image of a floating cell according to the present exemplary embodiment. The processing illustrated in FIG. 8 is executed such that the user operates the input device 1007 and the information processing unit 110 determines the number of cells resting at a cell focus position within the vessel A that is set on the mount portion (stage) 102 and contains a cell suspension. The information processing unit 110 executes the processing on an image to be used for determination every predetermined interval, for example, every several seconds, and measures the number of cells resting on the focus plane.

In step S800, a first image is acquired by focusing on the bottom of the vessel.

In step S801, an image of cells is acquired at a time different from the time in step S800 when the image is acquired by focusing on the bottom of the vessel.

In step S802, a change between the image acquired in step S801 and the image acquired in step S802 is calculated using the information processing unit 110. The change may be a difference or a ratio of a change. In this case, a difference will be described by way of example. If the change is less than or equal to the threshold (YES in step S803), the processing proceeds to step S804. In step S804, the cell region extraction process is performed. If the change is more than the threshold (NO in step S803), the processing returns to step S801 to acquire a third image. If the difference between the image acquired in step S801 and the acquired third image is less than or equal to the threshold (YES in step S803), the processing proceeds to step S804. In step S804, the cell region extraction process is performed. In step S804, the cell region extraction process, that is, a cell segmentation process is performed. In step S805, information about the inside and outside of the extracted cell region is acquired. In step S806, if the image capturing condition is not satisfied (NO in step S806), the processing returns to step S801 to repeatedly perform the determination process after a predetermined time interval, and then the processing proceeds to step S804 and step S805. In step S806, the determination process is repeatedly performed. If the image capturing condition is satisfied (YES in step S806), the processing proceeds to step S807. In step S807, a sound or an alert to be displayed on a screen is output on the display device 1006 illustrated in FIG. 1 to indicate that it is an appropriate image capturing timing. Alternatively, the user may make a setting to acquire a fluorescence image or an image desired by the user in step S808.

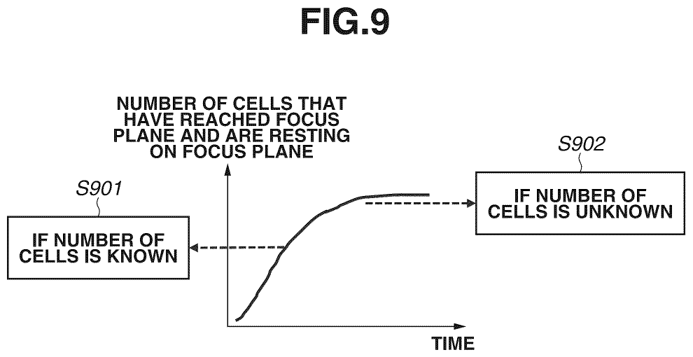

FIG. 9 is a conceptual diagram illustrating a user input condition to be selected by a program. In a case where the number of suspended cells is known, if a desired number of cells whose fluorescence images are to be finally captured are present, the desired number of cells or the like may be input as an input S901. If the number of suspended cells is unknown, it may be determined that the device is in a stable state as an input S902.

The exemplary embodiments of the present disclosure include the following configurations and method.

### Configuration 1

An image acquisition system configured to acquire an image of a floating cell included in a cell suspension within a vessel, the image acquisition system including a transmitted light image capturing unit configured to acquire a transmitted light image of the floating cell, a fluorescence image capturing unit configured to acquire a fluorescence image of the floating cell, and an information acquisition unit configured to acquire information about an image capturing condition for the fluorescence image using a first transmitted light image captured at a first time and a second transmitted light image captured at a second time different from the first time.

### Configuration 2

The image acquisition system according to Configuration 1, further including an image capturing control unit configured to control acquisition of the fluorescence image by capturing an image of the floating cell based on at least the information about the image capturing condition.

### Configuration 3

The image acquisition system according to Configuration 1 or 2, further including an image processing unit configured to perform processing of extracting a cell region in which the floating cell is present in the transmitted light image.

### Configuration 4

The image acquisition system according to Configuration 3, in which the image processing unit acquires image information about at least one of the cell region and a region outside of the cell region.

### Configuration 5

The image acquisition system according to any one of Configurations 1 to 4, in which the information acquisition unit acquires the image capturing condition based on a difference between luminance of a cell region in the first transmitted light image and luminance of a cell region in the second transmitted light image.

### Configuration 6

The image acquisition system according to any one of Configurations 1 to 5, further including an image capturing unit configured to acquire the transmitted light image and the fluorescence image by capturing an image of the floating cell.

### Configuration 7

The image acquisition system according to any one of Configurations 1 to 6, in which the information about the image capturing condition is at least one selected from the group consisting of information indicating that it is possible to capture the fluorescence image, information indicating a time when it is possible to capture the fluorescence image, information indicating that the number of floating cells present at a predetermined height within the vessel is more than or equal to a threshold, and information indicating that the floating cell is resting on a bottom surface of the vessel.

### Configuration 8

The image acquisition system according to any one of Configurations 1 to 7, further including a display control unit configured to control display of information about a timing for acquiring the fluorescence image on a display device based on the information about the image capturing condition.

### Method

An image acquisition method for acquiring an image of a floating cell included in a cell suspension within a vessel, the image acquisition method including a transmitted light image acquisition step of acquiring a transmitted light image of the floating cell, a fluorescence image acquisition step of acquiring a fluorescence image of the floating cell, and an information acquisition step of acquiring information about an image capturing condition for the fluorescence image using a first transmitted light image captured at a first time and a second transmitted light image captured at a second time different from the first time.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-050582, filed Mar. 26, 2024, which is hereby incorporated by reference herein in its entirety.

What is claimed is:

1. An image acquisition system configured to acquire an image of a floating cell included in a cell suspension within a vessel, the image acquisition system comprising:
a transmitted light image capturing unit configured to acquire a transmitted light image of the floating cell;
a fluorescence image capturing unit configured to acquire a fluorescence image of the floating cell; and
an information acquisition unit configured to acquire information about an image capturing condition for the fluorescence image using a first transmitted light image captured at a first time and a second transmitted light image captured at a second time different from the first time.

2. The image acquisition system according to claim 1, further comprising an image capturing control unit configured to control acquisition of the fluorescence image by capturing an image of the floating cell based on at least the information about the image capturing condition.

3. The image acquisition system according to claim 2, further comprising an image processing unit configured to perform processing of extracting a cell region in which the floating cell is present in the transmitted light image.

4. The image acquisition system according to claim 3, wherein the image processing unit acquires image information about at least one of the cell region and a region outside of the cell region.

5. The image acquisition system according to claim 1, wherein the information acquisition unit acquires the image capturing condition based on a difference between luminance of a cell region in the first transmitted light image and luminance of a cell region in the second transmitted light image.

6. The image acquisition system according to claim 1, wherein the image capturing unit configured to acquire the transmitted light image and the imaging capturing unit configured to acquire the fluorescence image by capturing an image of the floating cell are the same image capturing unit.

7. The image acquisition system according to claim 1, wherein the information about the image capturing condition is at least one selected from a group consisting of information indicating that it is possible to capture the fluorescence image, information indicating a time when it is possible to capture the fluorescence image, information indicating that a number of floating cells present at a predetermined height within the vessel is more than or equal to a threshold, and information indicating that the floating cell is resting on a bottom surface of the vessel.

8. The image acquisition system according to claim 1, further comprising a display control unit configured to control display of information about a timing for acquiring the fluorescence image on a display device based on the information about the image capturing condition.

9. An image acquisition method for acquiring an image of a floating cell included in a cell suspension within a vessel, the image acquisition method comprising:
acquiring a transmitted light image of the floating cell;
acquiring a fluorescence image of the floating cell; and
acquiring information about an image capturing condition for the fluorescence image using a first transmitted light image captured at a first time and a second transmitted light image captured at a second time different from the first time.
